(19) United States
(12) Patent Application Publication
(10) Pub. No.: US 2008/0266319 A1
(43) Pub. Date: Oct. 30, 2008

(54) Video processing apparatus and method

(75) Inventors: Kohei Momosaki, Kawasaki-shi (JP); Koji Yamamoto, Tokyo (JP); Tatsuya Uehara, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/076,059

(22) Filed: Mar. 13, 2008

(30) Foreign Application Priority Data
Apr. 27, 2007 (JP) 2007-119564

(51) Int. Cl. G09G 5/00

(52) U.S. Cl. 345/619

(57) ABSTRACT

A video processing apparatus stores video data in a memory, detects, from the video data, (a) a first display region of a first image object displayed for a first predetermined period of time or longer, (b) a first display interval indicating the start to end video frames in which the first image object is displayed, (c) a second display region of a second image object displayed within a predetermined range with reference to the first display region of the first image object, and (d) one or more second display intervals each indicating the start to end video frames in which the second image object is displayed, each second display interval being shorter than the first display interval, and generates a support data items used in at least one of a playback process, edit process, and search process of the video data, based on each second display interval.

### CROSS-REFERENCE TO RELATED APPLICATIONS

This application is based upon and claims the benefit of priority from prior Japanese Patent Application No. 2007-119564, filed Apr. 27, 2007, the entire contents of which are incorporated herein by reference.

### BACKGROUND OF THE INVENTION

1. Field of the Invention

The invention relates to a video processing apparatus and method, which process video data composited with text or image data on a screen.

2. Description of the Related Art

In recent years, with the growth of information infrastructures such as multi-channel broadcasting and the like, much video content is distributed. On a similar theme, on the recorder side, due to the prevalence of apparatuses such as a hard disc recorder, a personal computer with a built-in tuner, and the like, efficient viewing is allowed since video content can be saved and processed as digital data. As one of such processes, a function of dividing video content into some relevant scenes and allowing “cue” and “skip view” is available. The start points of these scenes are also called chapter points, and an apparatus automatically detects and sets chapter points or the user can set chapter points at arbitrary positions.

As a method of dividing video content into scenes, a method of detecting the appearance of a telop or ticker, and defining an interval in which a single telop appears as one scene is known. For example, in order to detect a telop, an image in one frame is divided into blocks, blocks in which the luminance levels and the like between two neighboring frames meet given conditions are extracted, and vertically or horizontally successive blocks are defined as a telop region (for example, see reference 1: JP-A 10-154148 (KOKAI)).

By extracting important scenes, a short video abstract can be created, and thumbnails can be created by determining representative frames of content. For example, in order to extract an important scene in sports video content, a method of detecting an exciting scene using cheers is known.

The user can make playback and edit processes based on chapter points for respective divided scenes. Also, the user can locate and selectively play back favorite content or a favorite scene based on thumbnails. Furthermore, the user can play back video content within a short period of time using summarized video data or data of a playlist used to summarize and play back the video content. In this way, support data is used in playback, edit, and search processes of video data.

Also, the logos of a company name, product name, and the like are popularly used as media of advertising throughout video content. A method of detecting the presence of such logo from video content, and analyzing the advertising effectiveness in broadcasting is known (for example, see reference 2: JP-A 2005-509962 (KOKAI)).

In some sports video content, telops that represent a score, progress of a game, and remaining time are displayed for a long period of time. By detecting appearance of such telop, a game part and other parts can be divided, but an important scene cannot be obtained in an interval in which a single telop is displayed.

It is difficult for the important scene extraction method using cheers to enhance the time precision. When the game time is short, it is more difficult to precisely extract an important scene from such game.

When an identical telop appears intermittently, if video content is divided with reference to intervals of appearance of that telop, it may be divided too often.

### BRIEF SUMMARY OF THE INVENTION

A video processing apparatus stores video data in a memory;

detects, from the video data, (a) a first display region of a first image object which is displayed for a first predetermined period of time or longer, (b) a first display interval indicating the start to end video frames in which the first image object is displayed, (c) a second display region of a second image object which is displayed within a predetermined range with reference to the first display region of the first image object, and (d) one or more second display intervals each indicating the start to end video frames in which the second image object is displayed, each second display interval being shorter than the first display interval; and

generates a support data items used in at least one of a playback process, edit process, and search process of the video data, based on each second display interval.

### BRIEF DESCRIPTION OF THE SEVERAL VIEWS OF THE DRAWING

FIG. 1 is a block diagram showing an example of the arrangement of a video processing apparatus according to the first embodiment;

FIGS. 2A and 2B are views for explaining a display region and display interval of a first image object;

FIGS. 3A and 3B are views for explaining a display region and display interval of a second image object;

FIG. 4 is a flowchart for explaining the processing operation of first and second image detectors;

FIG. 5 is a view for explaining the relationship between a spatio-temporal image and slice image;

FIG. 6 is a view for explaining a line segment detection method;

FIG. 7 is a flowchart for explaining the line segment detection method;

FIG. 8 is a view showing the distance between a pixel of interest and another pixel which is located on the same time axis as the pixel of interest;

FIG. 9 is a view showing an average of the distances between the pixel of interest and N neighboring pixels;

FIG. 10 is a view showing the distance between the pixel of interest and a pixel which neighbors the pixel of interest in a direction perpendicular to the time axis;

FIG. 11 is a view showing an average of the distances of N sets of neighboring pixels near the pixel of interest;

FIG. 12 is a view showing a difference between the distances from another neighboring set in the time-axis direction;

FIG. 13 is a view showing an average of the differences between the distances from N sets near the pixel of interest;

FIG. 14 is a view showing a practical example of an image object (first image object) detected from video data of a swimming race;

FIG. 15 is a view showing a practical example of image objects (first and second image objects) detected from video data of a swimming race;

FIG. 16 is a view showing a practical example of image objects (first and second image objects) detected from video data of a swimming race;

FIG. 17 is a view showing a practical example of image objects (first and second image objects) detected from video data of a soccer game;

FIG. 18 is a block diagram showing an example of the arrangement of a video processing apparatus according to the second embodiment;

FIGS. 19A and 19B are views for explaining display regions and display intervals of image objects detected from video data;

FIG. 20 is a flowchart for explaining the processing operation of an image detector and image selector;

FIG. 21 is a block diagram showing an example of the arrangement of a video processing apparatus according to the third embodiment;

FIG. 22 is a block diagram showing an example of the arrangement of a video processing apparatus according to the fourth embodiment; and

FIG. 23 is a view for explaining the processing operation of a combiner shown in FIG. 22.

### DETAILED DESCRIPTION OF THE INVENTION

### First Embodiment

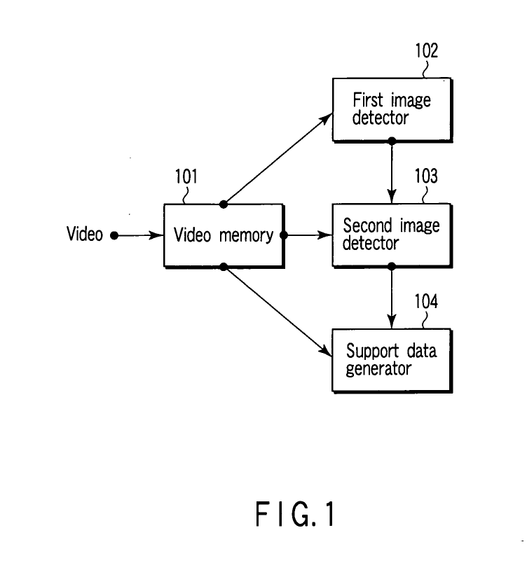

The video processing apparatus shown in FIG. 1 comprises a video memory 101, first image detector 102, second image detector 103, and support data generator 104.

The video memory 101 receives input video data, i.e., a plurality of time-serial video frames (video frame group). The video memory 101 stores the input video frame group as one spatio-temporal image.

The first image detector 102 detects, from the video frame group stored in the video memory 101, a display region 161 of a first image object, which is displayed for a predetermined period of time or longer (continuously in video frames of the predetermined number of frames or more), and a display interval 162 indicating the start to end video frames in which the object is displayed. The display interval 162 is the period of time during which the first image object is displayed. The first image detector 102 outputs first image object information including the position information of the display region 161 of the first image object in each video frame, and the display interval 162 of the first image object.

The second image detector 103 detects, based on the first image object information, a display region 171 of a second image object, which is displayed for a period of time shorter than the display interval 162 of the first image object (which is continuously displayed in video frames fewer than the number of video frames in which the first image object is displayed), from a predetermined range 163 with reference to the display region 161 in each video frame, and a display interval 172 indicating the-start and end video frames of the video frame group, in which the second image object is displayed. The display interval 172 is the period of time during which the second image object is displayed. The second image detector 103 then outputs second image object information including the position information of the display region 171 of the second image object in each video frame, and the display interval 172 of the second image object.

The support data generator 104 generates support data corresponding to the video frame group based on the display interval 172 of the second image object.

Note that the support data includes the start and end times of an interval used to execute a playback process, edit process, search process, and the like of video data, video data within the interval, and the like, and supports the user to execute the desired playback process, edit process, search process, and the like.

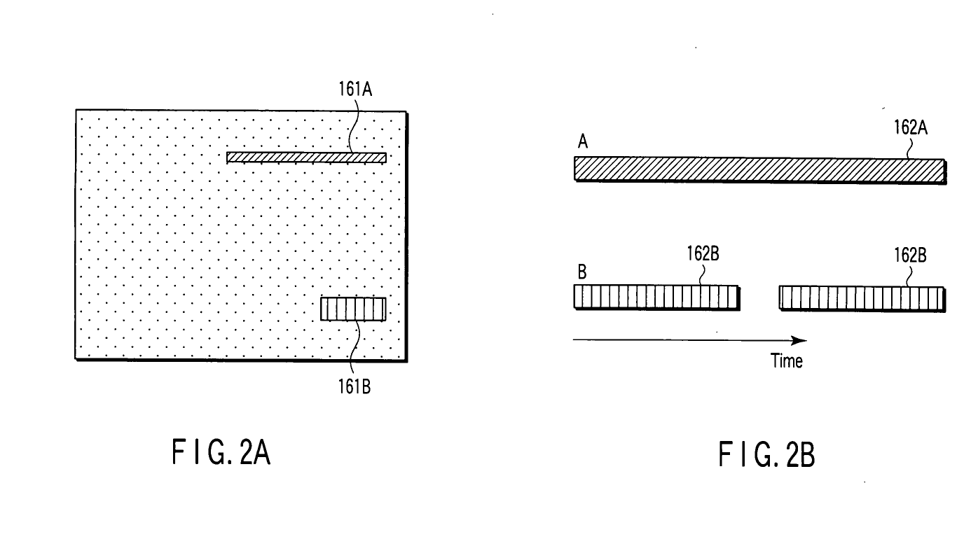

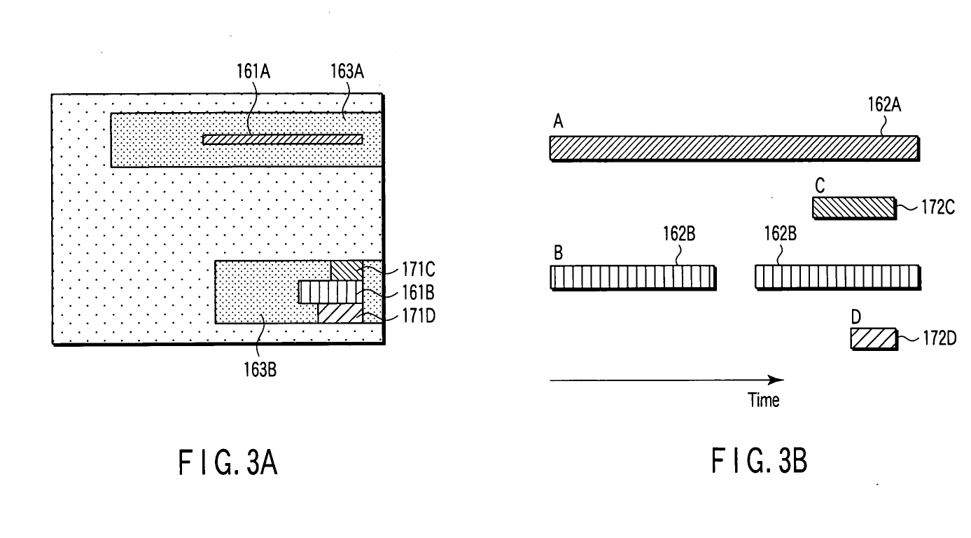

The display regions and display intervals of the first and second image objects detected by the first image detector 102 and second image detector 103 will be described below with reference to FIGS. 2A to 3B.

FIG. 2A shows an example of the display regions 161 of the first image objects detected by the first image detector 102 from the video frame group. FIG. 2A shows display regions 161A and 161B of two first image objects A and B.

FIG. 2B shows a display interval 162A corresponding to the first image object A, and display intervals 162B corresponding to the first image object B. The first image object A is. displayed for a long period of time from the left end to the right end in FIG. 2B, and the first image object B has a short non-display period near the center of the interval from the left end to the right end.

FIG. 3A shows an example of predetermined ranges 163A and 163B defined with reference to the display region 161A of the first image object A and the display region 161B of the first image object B, and display regions 171 of second image objects detected there. The predetermined range 163B defined with reference to the display region 161B includes second image objects C and D, and display regions 171C and 171D are shown as their display regions 171.

As shown in FIG. 3A, the predetermined ranges 163A and 163B are regions which contact the top, bottom, right, and left sides of the display regions 161A and 161B. Or these ranges 163A and 163B are regions within the predetermined distances from the top, bottom, right, and left sides of the display regions 161A and 161B.

The second image object is normally a rectangular, round rectangular, or elliptic graphic object, as shown in FIG. 3A.

FIG. 3B shows, with the horizontal axis plotting time, the display interval 162A of the first image object A and the display interval 162B of the first image object B, and also a display interval 172A of the second image object A and a display interval 172B of the second image object B.

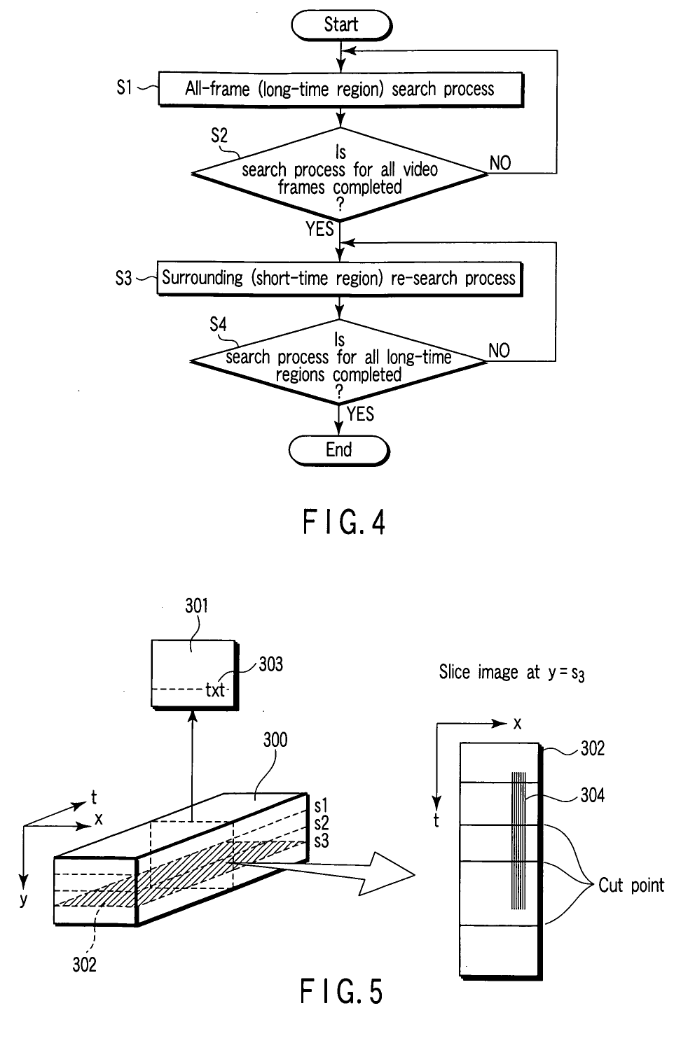

The sequence of the processing of the first and second image detectors 102 and 103 will be described below with reference to the flowchart of FIG. 4.

The first image detector 102 executes an all-frame (long-time region) search process (step S1). That is, the detector 102 searches all video frames of the video frame group, and detects a display region (e.g., the regions 161A and 161B in FIG. 2A) and display interval (e.g., the intervals 162A and 162B in FIG. 2B) of a first image object, which is displayed for a predetermined period of time or longer.

Upon completion of the search process for all the video frames (step S2), the first image detector 102 outputs first image object information including the position information of the detected display regions and display intervals of the first image objects. Note that the detected display region and display interval of the first image object will be referred to as a long-time region hereinafter.

The second image detector 103 executes a surrounding (short-time region) re-search process which has ranges surrounding the detected long-time regions as search ranges (step S3). That is, the detector 103 searches a predetermined range (e.g., the ranges 163A and 163B in FIG. 3A) around each detected display region of the first image object, and detects a display region (e.g., the regions 171C and 171D in FIG. 3A) and display interval (the intervals 172C and 172D in FIG. 3B) of a second image object, which is displayed for a time period shorter than the display interval of the first image object.

Upon completion of the search processes for all the detected long-time regions (step S4), the second image detector 103 outputs second image object information including the position information of the detected display regions and display intervals of the second image objects. Note that the detected display region and display interval of the second image object will be referred to as a short-time region hereinafter.

The all-frame (long-time region) search process in step S1 will be described below. In FIG. 5, reference numeral 300 denotes a spatio-temporal image which is defined by arranging the video frame group stored in the video memory 101 in chronological order to have the depth direction as the time axis. That is, the spatio-temporal image is a set including a plurality of video frames made by arranging video frames at corresponding times on the time axis in turn from video frames with earlier times. A video frame 301 is extracted from the spatio-temporal image.

The first image detector 102 cuts the spatio-temporal image 300 by one or more planes parallel to the time axis. The plane may be a horizontal plane (y=constant) or vertical plane (x=constant), or may be an oblique plane or curved plane. The first image detector 102 cuts the spatio-temporal image by curved planes to explore a position where a first image object such as a telop or the like is likely to exist. The detector 102 may cut the spatio-temporal image by a plane that cuts the neighborhood of the explored position. Since the first image object such as a telop or the like normally exists near the end of a frame, the detector 102 desirably cuts the spatio-temporal image by a plane that cuts the neighborhood of the end.

If there are a plurality of cut planes, a plurality of slice images are generated. By cutting the spatio-temporal image by a horizontal plane while shifting y in increments of 1, slice images as many as the height of the image are generated. In FIG. 5, for example, the spatio-temporal image is cut by planes at three positions y=s1, s2, and s3 to obtain three slice images. A slice image 302 is that at y=s3. On a slice image cut by a plane including a first image object 303 such as a telop or the like, an edge part between the first image object and background appears as a set 304 of a plurality of line segments. The first image detector 102 detects the set of these line segments as the display interval 162A or 162B, as shown in FIG. 2B. Note that the length of this line segment corresponds to a display time period.

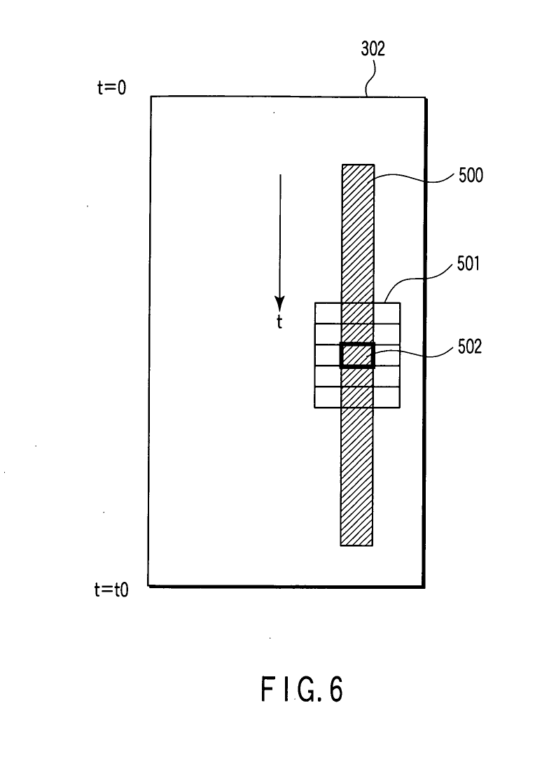

The line segment detection method will be described below with reference to FIGS. 6 to 13. In order to detect a line segment from an image, various methods are available, and an example of such methods will be described below.

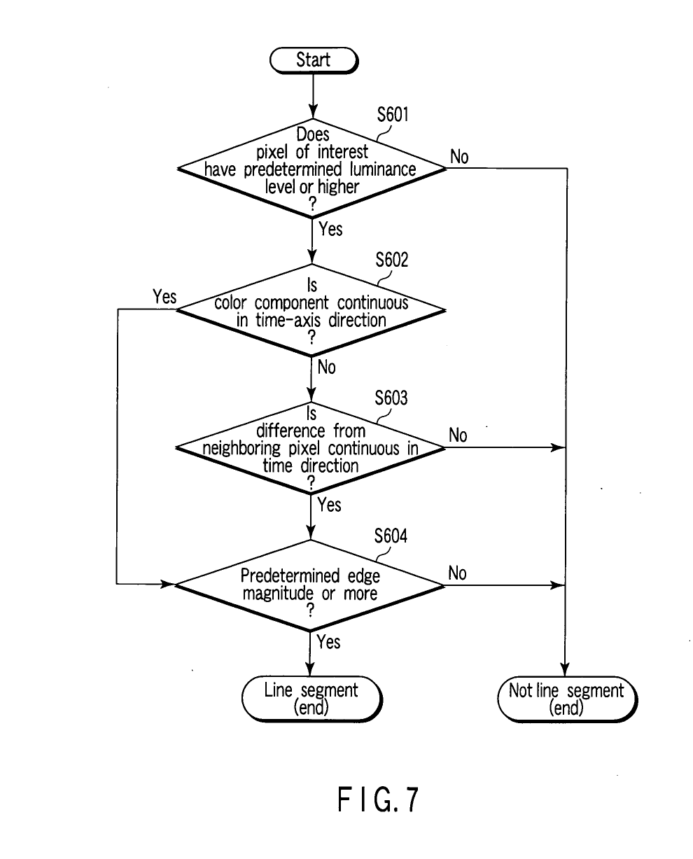

A line segment 500 in FIG. 6 is an enlarged view around one line segment of the line segment set 304 on the slice image 302 in FIG. 5. Reference numeral 501 denotes the allocations of some pixels including a pixel of interest 502 (in the bold line) as the center. A method of determining whether or not the pixel of interest 502 is a part of a line segment will be described below with reference to the flowchart shown in FIG. 7.

It is checked if the pixel of interest has a predetermined luminance level or higher (step S601). This is because a telop which can be the first object normally has a luminance level higher than the background. If the pixel of interest has a predetermined luminance level or higher, the process advances to step S602. Otherwise, it is determined that the pixel of interest is not a part of a line segment, thus ending the processing.

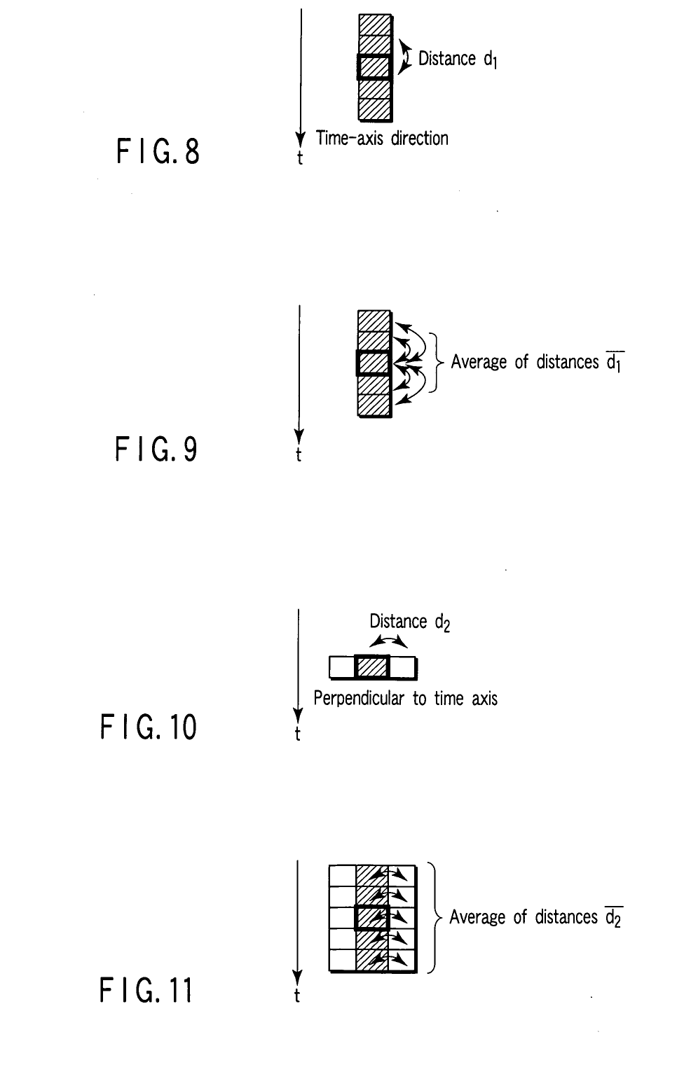

It is then checked if the pixel of interest is a color component which is continuous in the time-axis direction (step S602). As shown in FIG. 8, let d1 be the distance between the pixel of interest and another pixel on the same time axis, and if “d1<threshold”, it is determined that the pixel of interest is a color component which is continuous in the time-axis direction. As the distance, a distance of feature amounts such as colors, luminance levels, or the like is used. As the color distance, a Euclidean distance of RGB values or HSV values is known (where H is the hue, S is the saturation, and V is the luminance). As another method, as shown in FIG. 9, an average <d1>=Σd1/N of distances between the pixel of interest and its N neighboring pixels may be calculated, and if “<d1><threshold”, it may be determined that the pixel of interest is a color component which is continuous in the time-axis direction. In this case, N is defined in advance (the same applies to the following description). If the pixel of interest is a color component which is continuous in the time-axis direction, the process jumps to step S604; otherwise, the process advances to step S603.

It is then checked if the pixel of interest has a predetermined edge magnitude or higher (step S604). As shown in FIG. 10, let d2 be the distance between the pixel of interest and a pixel which neighbors the pixel of interest in a direction perpendicular to the time axis, and if “d2>threshold”, it is determined that the pixel of interest has a predetermined edge magnitude or higher. As another method, as shown in FIG. 11, an average <d2>=Σd2/N of distances of N sets of pixels which neighbor the pixel of interest may be calculated, and if “<d2>>threshold”, it may be determined that the pixel of interest has a predetermined edge magnitude or higher. If the pixel of interest has a predetermined edge magnitude or higher, it is determined that the pixel of interest is a part of a line segment, thus ending the processing. Otherwise, it is determined that the pixel of interest is not a part of a line segment, thus ending the processing.

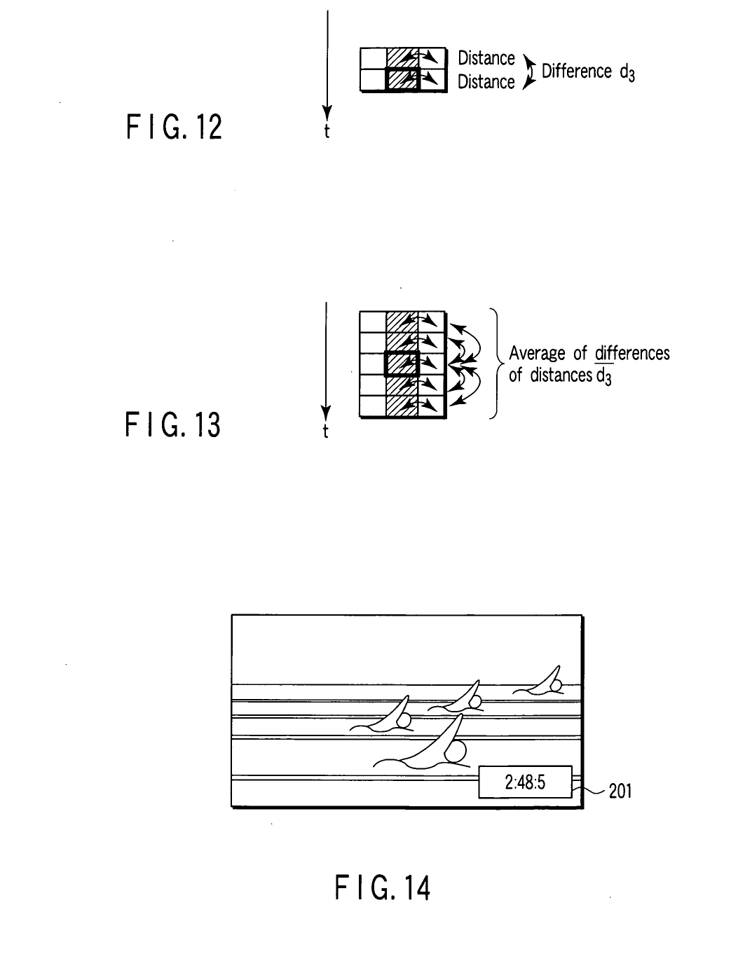

In order to allow detection of a translucent line segment, it is checked if a difference calculated by subtracting the color component of a neighboring pixel from the edge magnitude of the pixel of interest is continuous in the time-axis direction (step S603). If it is determined that the difference calculated by subtracting the color component of the neighboring pixel from the edge magnitude of the pixel of interest is continuous in the time direction, the process advances to step S604; otherwise, it is determined that the pixel of interest is not a part of a line segment, thus ending the processing. A difference for each distance color component of a set including the pixel of interest and its neighboring pixel is calculated as in FIG. 10, and a difference distance d3 from another set which neighbors the set of the pixel of interest in the time-axis direction is calculated, as shown in FIG. 12. If “d3<threshold”, it is determined that the difference calculated by subtracting the color component of the neighboring pixel from the edge magnitude of the pixel of interest is continuous in the time direction. As another method, as shown in FIG. 13, an average <d3>=Σd3/N of difference distances of N sets that neighbor the pixel of interest may be calculated, and if “<d3><threshold”, it may be determined that the difference calculated by subtracting the color component of the neighboring pixel from the edge magnitude of the pixel of interest is continuous in the time direction.

The flowchart of FIG. 7 is merely an example, and not all of the processes in steps S601 to S604 are always required, and determination may be made using the sequence including only some of these processes, or that including these processes in a different order, or that including other processes. Other processes include a line segment expansion process, threshold process, and the like required to couple or remove segmented small regions.

The line segment expansion process is a post-process of the flowchart in FIG. 7, and checks if, for example, five or more out of nine pixels around the pixel of interest form a line segment. If the five or more pixels form a line segment, it is determined that the pixel of interest is also included in the line segment; otherwise, it is determined that the pixel of interest is not included in the line segment, thus expanding the line segment. The line segment threshold process couples the pixel of interest to another line segment or erases the pixel of interest. For example, when the pixel of interest is sandwiched between two line segments, the two line segments are coupled to obtain one line segment, and the pixel of interest is included in the new line segment. Also, when the pixel of interest is separated apart from a line segment by a predetermined distance or more, that line segment is erased.

The first image detector 102 detects a set of line segments whose length (time) has a predetermined value or more, as described above, and detects the position where the set of line segments in the slice image is detected, and the length (interval) of the line segment as the position of the display region and display interval of the first image object.

The surrounding (short-time region) re-search process in step S3 will be described below. The second image detector 103 cuts the spatio-temporal image 300 in FIG. 5 near the display region of the first image object, and detects a set of line segments shorter than the line segments corresponding to the first image object as in the aforementioned all-frame (long-time region) search process. The second image detector 103 then detects the position where the set of line segments in the slice image is detected, and the length of the line segment as the position of the display region and display interval of the second image object.

Practical examples of image objects to be detected will be described below with reference to video frames shown in FIGS. 14 to 17.

FIGS. 14 to 16 show examples of video frames of a swimming race. As shown in FIG. 14, time (elapse) 201 is normally displayed on the corner of the frame from the beginning to the end of the race.

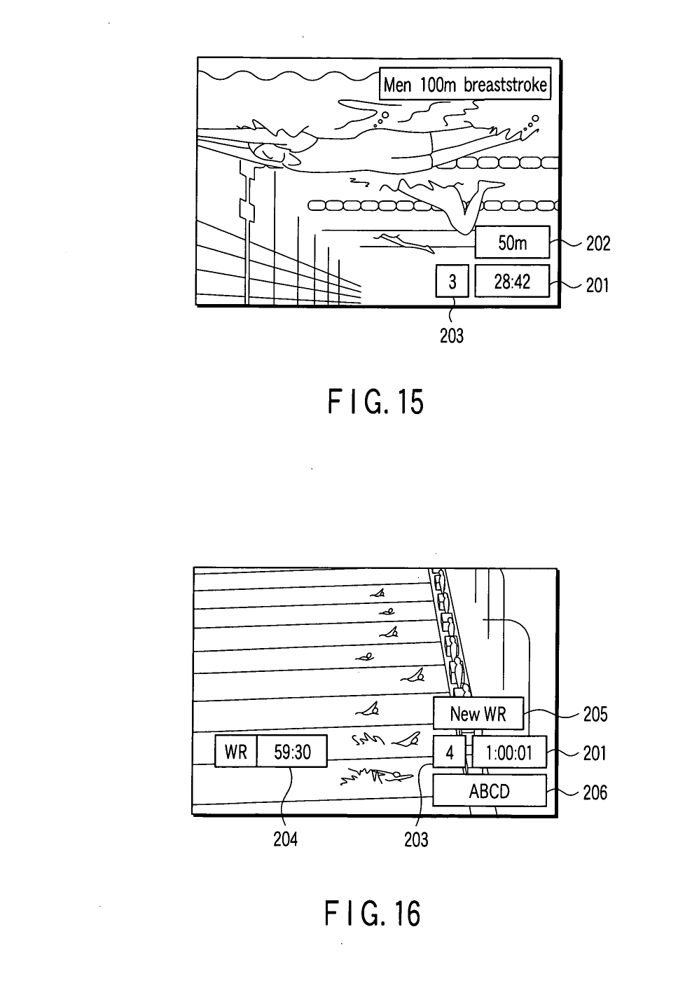

As shown in FIG. 15, pieces of information of note (in FIG. 15, “50 m” indicating a 50-m turn and “3” indicating the third course of a top swimmer) 202 and 203 are often displayed. Also, as shown in FIG. 16, a current world record “WR” 204 is displayed in synchronism with the goal timing (several seconds before the goal), or a new world record “New WR” is displayed immediately after the goal. Furthermore, in especially a large-scale international swimming race or the like, upon production of an international video image to be distributed worldwide, design letters (logo) 206 such as a brand name, corporate name, or the like are often displayed as an advertisement in a region in contact with the time display region for several seconds (generally, five seconds or less) in synchronism with the goal timing.

From the video frames shown in FIGS. 14 to 16, a part of the time 201 is detected as a first image object, and parts of pieces of information 202 to 206 shown in FIGS. 15 and 16 are detected as second image objects.

The same applies to video data of time races such as a sprint race of a track and field event, bicycle race, boat race, alpine skiing, and the like as those of the swimming race.

In video data of judo, the time (remaining time) is displayed on the corner of a frame from the beginning to the end of a match. When one earned the victory by ippon, the logo is often displayed as in FIG. 16. However, since it is difficult to display such logo in advance in synchronism with the timing of ippon victory decided instantaneously, the logo display timing is normally delayed from the ippon victory, and an important scene is likely to appear considerably before the logo. In this manner, the logo display interval preferably differs from the time interval of an important scene according to the type of sports.

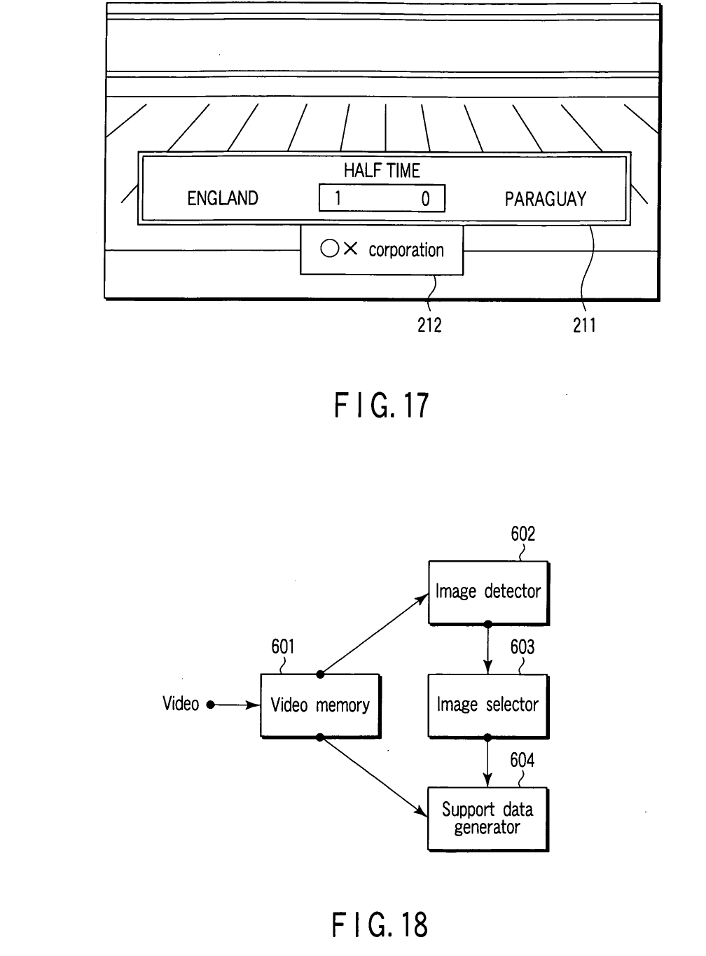

FIG. 17 shows an example of a video frame of a soccer match. A score is normally displayed together with the time (elapse). Both of these pieces of information may be kept displayed in some cases. Alternatively, the score may be displayed as needed. In international video distribution, the score is displayed for a relatively long period of time (e.g., 8 seconds), but the display interval of the logo near the score is normally short (e.g., 5 seconds). In this case, a score display part 211 is detected as one of first image objects, and a logo part 212 is detected as a second image object. In this way, the invention is applicable to a match that focuses on the score rather than the time.

Support data to be generated by the support data generator 104 will be described below.

Based on the display intervals 172 included in the second image object information, the support data generator 104 selects the intervals of important scenes, creates abbreviated video data that connects the selected important scenes, creates representative images, and calculates the start times of a plurality of respective intervals used in “cueing” or the like by dividing video data into the intervals. These important scenes, abbreviated video data, representative images, video data set with the start points of respective intervals used in “cueing” or the like as chapter points (cue points), and the like will be referred to as support data hereinafter.

The intervals of video data used upon generation of these support data by the support data generator 104 may be the same as the display intervals 172. However, the invention is not limited to this. For example, an interval including those before and after the display interval 172, i.e., an interval from several seconds before the beginning of the display interval 172 (corresponding to an exciting scene immediately before the goal) until several seconds after the end of the display interval 172 (corresponding to a goal scene of players in a stream and insertion of a closeup shot of a winner) may be used.

For example, the support data generator 104 extracts, as an important scene, a predetermined interval with reference to the display interval 172 of the second image object (e.g., an interval from several seconds before the start time of the display interval 172 until several seconds after the end time of the display interval 172). The generator 204 selects a representative image from the interval extracted as the important scene. When a plurality of display intervals 172 are detected, the generator 104 extracts important scenes in correspondence with the respective display intervals 172, and generates abbreviated video data by connecting video data of the intervals extracted as these important scenes.

Upon creating the abbreviated video data and representative image, the predetermined interval may include the display interval of the second image object. However, when the second image object is associated with the result of a game (or a race, match, or the like), and especially in sports, if one knows the result at the very beginning of a video, the viewing purpose of that video may be impaired. Therefore, upon creating the abbreviated video data and representative image, it is desired that the predetermined interval does not include the display interval of the second image object. In this case, the abbreviated video data and representative image are created from intervals before and after the display interval 172 of the second image object by excluding the display interval 172 from the predetermined interval (e.g., an interval from several seconds before the start time of the display interval 172 until several seconds after the end time of the display interval 172) with reference to the display interval 172. Alternatively, after the display region of the second image object is deleted from the frame that displays the second image object within the predetermined interval, or a blurring process is applied to that display region to make it unidentifiable, the abbreviated video data and representative image are created. When the second image object is a logo, it is often desired that the abbreviated video data and representative image do not include the logo more than necessary, and it is desirable to apply the same process in this case as well.

The support data generator 104 determines chapter points (or cue points or random access points) as support data in video data so that the user can easily cue and view each display interval 172. For example, the generator 104 determines, as an random point, a spot (time) a predetermined period of time before the start time of the display interval 172 of each second image object. To allow cueing, one can skip non-display intervals of the second image objects upon viewing. The support data generator 104 generates, as support data, video data in which chapter points (or random access points or cue points) are set at the determined spot.

As described above, according to the first embodiment, an important scene of video frames of sports or the like can be precisely extracted (as support data), and more appropriate abbreviated video data, thumbnail data, and promotion video data can be created as support data. Upon dividing video data of sports or the like, intervals suited to be divided can be obtained.

### Second Embodiment

A video processing apparatus according to the second embodiment will be described below with reference to FIG. 18.

The video processing apparatus shown in FIG. 18 comprises a video memory 601, image detector 602, image selector 603, and support data generator 604.

The video memory 601 receives input video data, i.e., a plurality of time-series video frames (to be referred to as a video frame group hereinafter), and stores the input video frame group as one spatio-temporal image, as in the video memory 101 of the first embodiment.

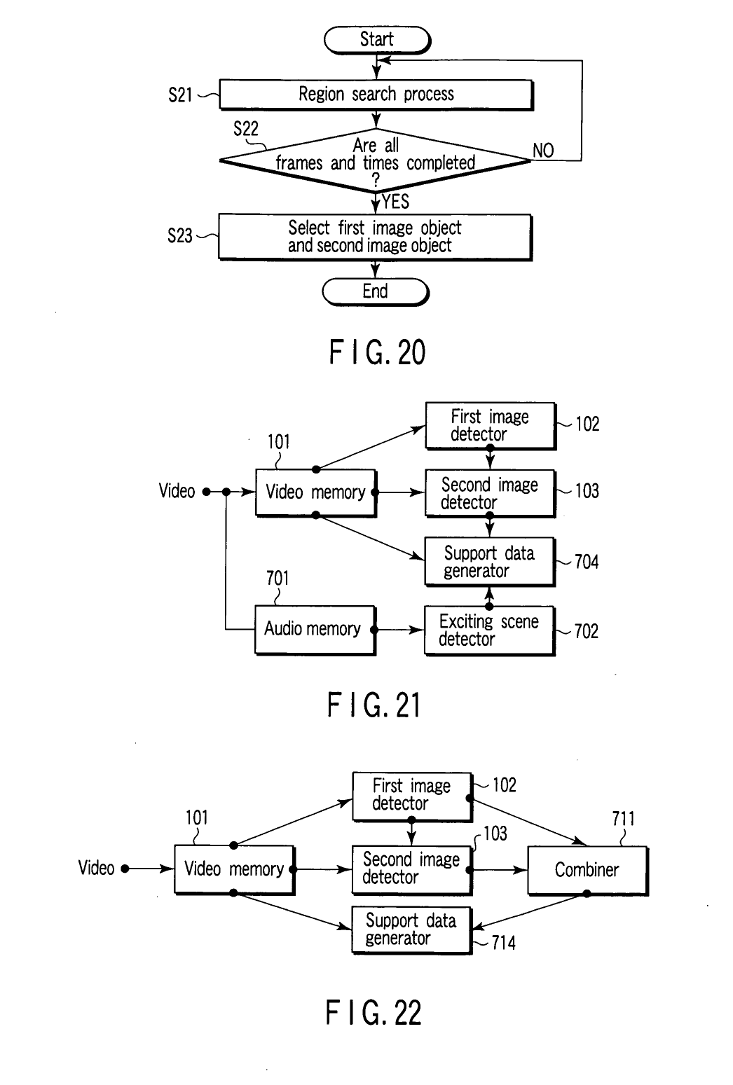

The image detector 602 and image selector 603 will be described below with reference to the flowchart of FIG. 20.

In step S21 in FIG. 20, the image detector 602 executes the same process (see FIG. 7) as that of the first image detector 102 described in the first embodiment to detect a display region 180 of an image object which is displayed for a predetermined first time period or longer (continuously in video frames of the predetermined first number of frames or more) for the video frame group stored in the video memory 601, and a display interval 181 indicating the start to end video frames in which the image object is displayed. Upon completion of the search process for all video frames (step S22), the detector 602 outputs image object information including the position information of the detected display region and the display interval of the image object.

In step S23 of FIG. 20, the image selector 603 selects, as a first image object, an image object, which is displayed for a predetermined second time period or longer which is longer than the first time period (continuously in video frames of the predetermined second number of frames or more which is larger than the first number of frames) from the image objects whose display regions and display intervals are detected, with reference to the image object information, thus obtaining its display region and display interval. The display region and display interval correspond to the display region 161 and display interval 162 of the first image object of the first embodiment. Furthermore, the selector 603 selects, as a second image object, an image object whose display interval is shorter than the second time period, from the predetermined range 163 with reference to the display region of the first image object, and obtains a display region and display interval of that second image object. The display region and display interval correspond to the display region 171 and display interval 172 of the second image object of the first embodiment. The selector 603 then outputs second image object information including the position information of the display region 171 and the display interval 172 of each second image object in each video frame.

The support data generator 604 generates support data corresponding to the video frame group based on the display interval 172 of each second image object.

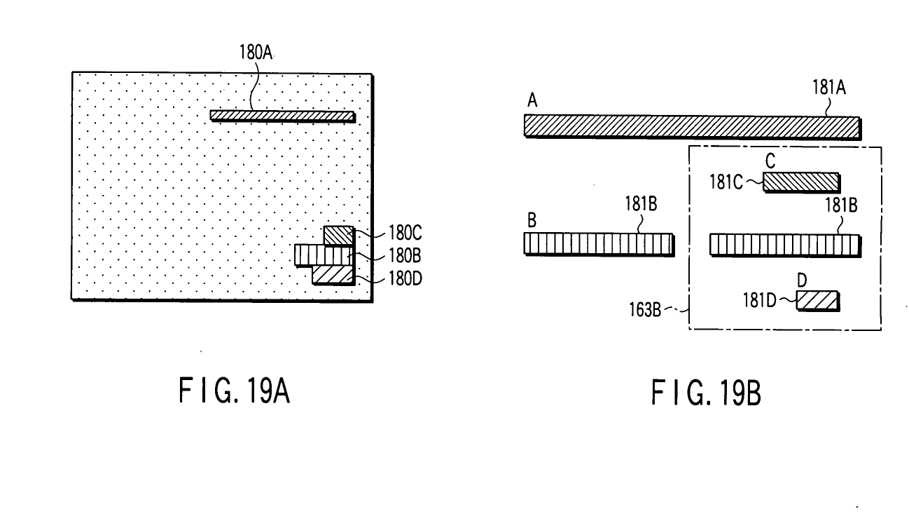

Image objects detected by the image detector 602 and first and second image objects will be described below with reference to FIGS. 19A and 19B.

FIG. 19A shows an example of display regions 180 of image objects detected from the video frame group by the image detector 602. FIG. 19A shows display regions 180A to 180D of four image objects A to D.

FIG. 19B shows, with the horizontal axis plotting time, a display interval 181A corresponding to the image object A, a display interval 181B corresponding to the image object B, a display interval 181C corresponding to the image object C, and a display interval 181D corresponding to the image object D.

The image detector 602 detects the display regions and display intervals of these image objects by the sequence shown in FIG. 7.

The image object A is displayed for a long period of time from the left end to the right end in FIG. 19B, and the image object B has a short non-display interval near the center of the interval from the left end to the right end. The image objects C and D are displayed in only shorter intervals.

The image selector 603 selects, from these image objects A to D, the image objects A and B whose display intervals are equal to or longer than the first time period as first image objects. Then, the image selector 603 selects second image objects from predetermined ranges with reference to the first image objects A and B. A part bounded by the dotted line in FIG. 19B indicates a predetermined range 183B with reference to the image object B. The image selector 603 selects the image objects C and D which exist within this range 183B as second objects.

The support data generator 604 is the same as the support data generator 104 in the first embodiment. That is, the generator 604 selects important scenes, creates abbreviated video data and representative images, and allows cueing based on the information of the display intervals 181 of the second image objects.

As described above, according to the second embodiment, an important scene of video frames of sports or the like can be precisely extracted (as support data), and more appropriate abbreviated video data, thumbnail data, and promotion video data can be created as support data, as in the first embodiment. Upon dividing video data of sports or the like, intervals suited to be divided can be obtained.

### Third Embodiment

A video processing apparatus according to the third embodiment will be described below with reference to FIG. 21.

Note that the same reference numerals in FIG. 21 denote the same parts as in FIG. 1, and only differences will be described below. More specifically, the video processing apparatus shown in FIG. 21 comprises a support data generator 704, which replaces the support data generator 104 in FIG. 1, and also an audio memory 701 and exciting scene detector 702, in addition to the video memory 101, first image detector 102, and second image detector 103 shown in FIG. 1.

The audio memory 701 stores audio data included in input video data in association with video frames (e.g., the playback time of a video frame group or frame numbers of respective video frames).

The exciting scene detector 702 analyzes the audio data stored in the audio memory 701, and detects the time or interval of an exciting scene based on the tone levels of cheers and applause.

The support data generator 704 generates support data corresponding to the video frame group based on the display intervals 172 of the second objects and the time or interval of the exciting scene detected by the exciting scene detector 702.

For example, when the time or the start time of the interval of the exciting scene exists during an interval a predetermined time period (e.g., 1 minute) before the start timing of the display interval of the second image object, the support data generator 704 determines, as a cue point (chapter point), a time the predetermined time period before the start time of the display interval of the second image object, or the time of the exciting scene or the start time of the existing scene interval. The generator 704 generates, as support data, video data set with this time as a cue point (chapter point).

As described above, according to the third embodiment, an important scene of video frames of sports or the like can be precisely extracted (as support data), and more appropriate abbreviated video data, thumbnail data, and promotion video data can be created as support data as in the first and second embodiments. Upon dividing video data of sports or the like, intervals suited to be divided can be obtained.

### Fourth Embodiment

A video processing apparatus according to the fourth embodiment will be described below with reference to FIG. 22.

Note that the same reference numerals in FIG. 22 denote the same parts as in FIG. 1, and only differences will be described below. That is, the video processing apparatus shown in FIG. 22 comprises a support data generator 714, which replaces the support data generator 104 in FIG. 1, and also a combiner 711, in addition to the video memory 101, first image detector 102, and second image detector 103.

The combiner 711 combines an interval in which no second image object is displayed of a plurality of display intervals of a first image object detected by the first image detector 102 with the subsequent display interval of the first image object. Note that the combiner 711 may not combine intervals when the distance to the subsequent display interval is equal to or longer than a predetermined time period. As a result, the display interval of the second object is not combined with the subsequent interval, and is located at the end of the interval.

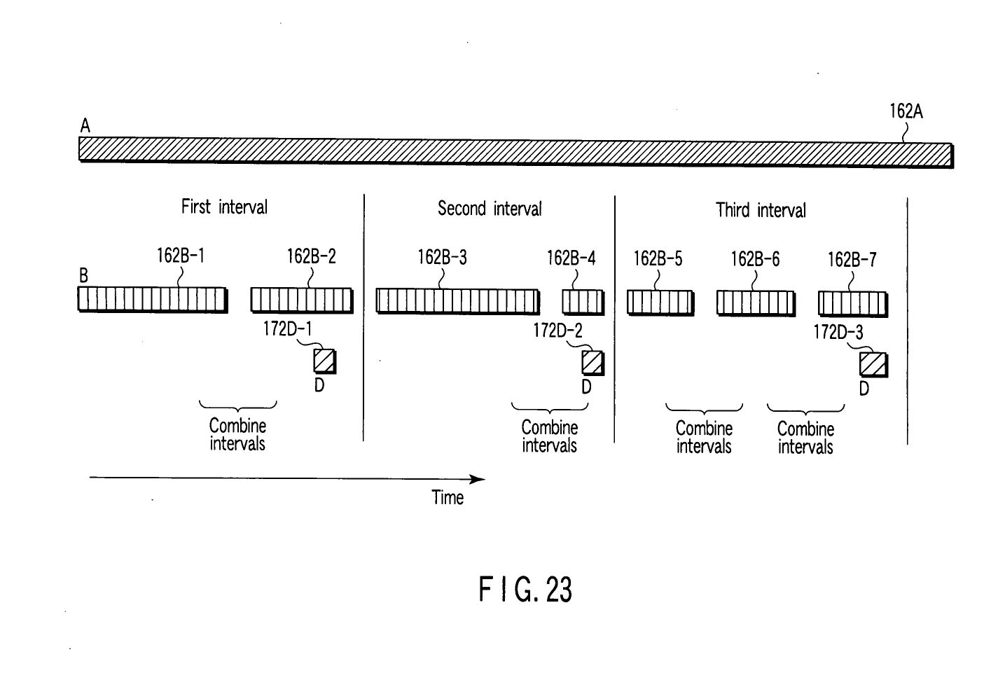

For example, assume that the first image detector 102 detects display intervals 162A and 162B of two first image objects A and B from a video frame group, and the second image detector 103 detects display intervals 172D of a second image object D, as shown in FIG. 23. Note that in FIG. 23, the horizontal axis plots time to indicate respective display intervals.

Also, in FIG. 23, a plurality of display intervals 162B-1 to 162B-7 detected by the first image detector 102 undergo clustering based on the similarities of feature amounts such as positions, colors, and the like in video frames in the first image detector 102, so as to be grouped into the display interval 162B of one image object B. Since the total time period of the display intervals 162B-1 to 162B-7 is equal to or longer than a predetermined time period, the plurality of display intervals 162B-1 to 162B-7 are detected as those of the first image object B.

Furthermore, a plurality of display intervals 172D-1 to 172D-3 detected from a predetermined range with reference to the display region of the first image object B by the second image detector 103 undergo clustering based on the similarities of feature amounts such as positions, colors, and the like in video frames in the second image detector 103, so as to be grouped into the display interval 172D of one image object D.

As shown in FIG. 23, the display interval 162B-2 of the first image object B includes the display interval 172D-1 of the second image object D, the display interval 162B-4 of the first image object B includes the display interval 172D-2 of the second image object D, and the display interval 162B-7 of the first image object B includes the display interval 172D-3 of the second image object D.

The combiner 711 combines the display interval 162B-1 of the first image object B with the subsequent display interval 162B-2, since the display interval 162B-1 does not include any display interval of the second image object. The combiner 711 does not combine the display interval 162B-2 with the subsequent display interval 162B-3, since the display interval 162B-2 includes the display interval 172D-1 of the second image object D. Likewise, the combiner 711 combines the display interval 162B-3 of the first image object B with the subsequent display interval 162B-4 (including the display interval 172D-3 of the second image object D) since the display interval 162B-3 does not include any display interval of the second image object. Furthermore, the combiner 711 combines the display intervals 162B-5 and 162B-6 of the first image object B with the subsequent display interval 162B-7 (including the display interval 172D-3 of the second image object D) since the display intervals 162B-5 and 162B-6 do not include any display interval of the second image object.

The support data generator 714 divides video data into a first interval including the display intervals 162B-1 and 162B-2, a second interval including the display intervals 162B-3 and 162B-4, and a third interval including the display intervals 163B-5 to 162B-7, based on the combining result of the combiner 711. The support data generator 714 sets the start times of the respective intervals in the video data as start points of chapters, thus generating support data.

As described above, according to the fourth embodiment, an important scene of video frames of sports or the like can be precisely extracted (as support data), and more appropriate abbreviated video data, thumbnail data, and promotion video data can be created as support data, as in the first to third embodiments. Upon dividing video data of sports or the like, intervals suited to be divided can be obtained.

The method of the invention (especially, components shown in FIGS. 1, 18, 21, and 22) described in the embodiments of the invention can be stored, as a program that can be executed by a computer, in a recording medium such as a magnetic disc (flexible disc, hard disc, or the like), an optical disc (CD-ROM, DVD, or the like), a semiconductor memory, and the like, and the recording medium can be distributed.

As described above, according to the first to fourth embodiments, important scenes in video data of sports and the like can be precisely extracted, and intervals suited to be divided can be obtained.

What is claimed is:

1. A video processing apparatus comprising:
a storage unit configured to store video data;
a detection unit configured to detect, from the video data, (a) a first display region of a first image object which is displayed for a first predetermined period of time or longer, (b) a first display interval indicating the start to end video frames in which the first image object is displayed, (c) a second display region of a second image object which is displayed within a predetermined range with reference to the first display region of the first image object, and (d) one or more second display intervals each indicating the start to end video frames in which the second image object is displayed, each second display interval being shorter than the first display interval; and
a generation unit configured to generate a support data items used in at least one of a playback process, edit process, and search process of the video data, based on each second display interval.

2. The apparatus according to claim 1, wherein the detection unit comprises:
a first detection unit configured to detect the first display region and the first display interval of the first image object from the video data; and
a second detection unit configured to detect the second display region and the one or more second display intervals of the second image object.

3. The apparatus according to claim 1, wherein the detection unit comprises:
a unit configured to detect, from the video data, a plurality of image objects which are displayed for a second predetermined period of time or longer, a display region of each image object, and a display interval of each image object, the second predetermined period of time being shorter than the first predetermined period of time, and the display interval indicating the start to end video frames in which the image object is displayed;
a selection unit configured to select, from the image objects, the first image object and the second image object.

4. The apparatus according to claim 1, wherein the generation unit generates the support data by extracting, from the video data, an important interval from several seconds before a start time of each second display interval until several seconds after an end time of the second display interval.

5. The apparatus according to claim 1, wherein the generation unit (a) extracts, from the video data, an important interval from several seconds before a start time of each second display interval until several seconds after an end time of the second display interval, to obtain a plurality of important intervals and (b) connects the important intervals, to obtain abbreviated video data as the support data.

6. The apparatus according to claim 4, wherein the generation unit selects, from the important interval, a representative image as the support data.

7. The apparatus according to claim 4, wherein the generation unit (a) deletes, from the important interval, the second display interval or the second object, and (b) generates the support data by using the important interval from which the second display interval or the second object is deleted.

8. The apparatus according to claim 1, wherein the generation unit generates the video data in which a cue point is set at a spot a predetermined time period before a start time of each second display interval as the support data.

9. The apparatus according to claim 1, further comprising:
an exciting scene detection unit configured to detect a time or an interval of an exciting scene from audio data included in the video data, and
wherein the generation unit generates, when the time of the exciting scene or a start time of the interval of the exciting scene is within a predetermined time period before a start time of the second display interval, the video data in which a cue point is set at the time of the exciting scene or the start time of the interval of the exciting scene as the support data.

10. The apparatus according to claim 9, wherein the exciting scene detection unit detects cheers or applause included in the audio data.

11. The apparatus according to claim 1, wherein the detection unit detects a plurality of first display intervals of the first image object and a plurality of second display intervals of the second image object.

12. The apparatus according to claim 11, further comprising:
a combining unit configured to combine first one of the first display intervals with second one of the first display intervals which is subsequent to the first one, the first one including no second display interval, to generate new first display intervals; and wherein
the generation unit generates the support data by dividing the video data based on the new first intervals.

13. The apparatus according to claim 12, wherein the combining unit (a) combines the second one with third one of the first display intervals which is subsequent to the second one, when the second one including no second display interval, and (b) dose not combine the second one with the third one, when the second one including one of the second display intervals.

14. The apparatus according to claim 1, wherein the predetermined range with reference to the first display region of the first image object is a region which contacts top, bottom, right, and left sides of the display region, or a region within predetermined distances from the top, bottom, right, and left sides.

15. The apparatus according to claim 1, wherein the detection unit extracts a set of line segments parallel to a time axis from a slice image obtained by cutting a spatio-temporal image in which a plurality of video frames of the video data are arranged in a chronological order, by a plane parallel to the time axis, and detects the first display region and the first display interval of the first image object based on a length of the set of line segments.

16. The apparatus according to claim 1, wherein the second image object is a rectangular, round rectangular, or elliptic graphic object.

17. The apparatus according to claim 1, wherein the second display interval is not more than five seconds.

18. A video processing method including:
storing video data in a memory;
detecting, from the video data, (a) a first display region of a first image object which is displayed for a first predetermined period of time or longer, (b) a first display interval indicating the start to end video frames in which the first image object is displayed, (c) a second display region of a second image object which is displayed within a predetermined range with reference to the first display region of the first image object, and (d) one or more second display intervals each indicating the start to end video frames in which the second image object is displayed, each second display interval being shorter than the first display interval; and
generating a support data used in at least one of a playback process, edit process, and search process of the video data, based on each second display interval.

19. The method according to claim 18, wherein the detecting includes:
detecting, from the video data, a plurality of image objects which are displayed for a second predetermined period of time or longer, a display region of each image object, and a display interval of each image object, the second predetermined period of time being shorter than the first predetermined period of time, and the display interval indicating the start to end video frames in which the image object is displayed;
selecting, from the image objects, the first image object and the second image object.
